(19) United States
(12) Patent Application Publication
(10) Pub. No.: US 2017/0334391 A1
(43) Pub. Date: Nov. 23, 2017

(54) BUCKLE

(71) Applicant: Atsushi FUJII, Shiga (JP)

(72) Inventor: Atsushi FUJII, Shiga (JP)

(73) Assignee: Takata Corporation, Tokyo (JP)

(21) Appl. No.: 15/590,361

(22) Filed: May 9, 2017

(30) Foreign Application Priority Data
May 20, 2016 (JP) 2016-101321

(51) Int. Cl. B60R 22/02; B60R 22/22; B60R 22/24; B60R 22/18

(52) U.S. Cl. CPC B60R 22/02; B60R 22/24; B60R 22/22; B60R 22/023; B60R 22/18; B60R 2022/1806; B60R 2022/1812

(57) ABSTRACT

A buckle includes a main body part that can be coupled to a tongue that is attached to a seatbelt of a vehicle; a communication substrate to which one end of a wire harness is coupled, the wire harness passing through an opening formed on a buckle surface of the buckle; a holder configured to support the communication substrate; and a cover configured to cover the main body part, the communication substrate, and the holder. The cover includes a rib that prevents the holder from moving in an opening direction of the opening.

### BACKGROUND OF THE INVENTION

### 1. Field of the Invention

The disclosures herein relate to a buckle.

### 2. Description of the Related Art

Conventionally, there is known a configuration in which the driving chip inside a buckle is coupled to an ECU (Electronic Control Unit) via a LIN (Local Interconnect Network) wire (see, for example, Patent Document 1).
Patent Document 1: Chinese Patent Application Publication No. 103538556

However, when one end of a wire harness is coupled to a substrate for communication (communication substrate) such as LIN, etc., and a tensile force is applied to the wire harness, the communication substrate may fall off due to the tensile force.

### SUMMARY OF THE INVENTION

It is a general object of the present invention to provide a buckle that substantially obviates one or more problems caused by the limitations and disadvantages of the related art.

According to an embodiment, a buckle includes a main body part that can be coupled to a tongue that is attached to a seatbelt of a vehicle; a communication substrate to which one end of a wire harness is coupled, the wire harness passing through an opening formed on a buckle surface of the buckle; a holder configured to support the communication substrate; and a cover configured to cover the main body part, the communication substrate, and the holder, wherein the cover includes a rib that prevents the holder from moving in an opening direction of the opening.

According to at least one embodiment, even when the wire harness is pulled in the opening direction, the holder supporting the communication substrate is prevented from moving in the opening direction by the rib, and therefore the communication substrate is prevented from falling off from the cover in the opening direction together with the holder.

According to at least one embodiment, the communication substrate is prevented from falling off due to the pulling of the wire harness.

### BRIEF DESCRIPTION OF THE DRAWINGS

Other objects and further features of the present invention will be apparent from the following detailed description when read in conjunction with the accompanying drawings, in which:

FIG. 1 illustrates an example of a configuration of a seatbelt apparatus according to an embodiment;

FIG. 2 illustrates an example of a buckle from a viewpoint from the upper part of the vehicle;

FIG. 3 is an exploded perspective view of an example of the configuration of the buckle;

FIG. 4 is a perspective view of an example of a communication module;

FIG. 5 is an exploded perspective view of an example of the communication module;

FIG. 6 illustrates an example of the buckle from the viewpoint from the upper cover;

FIG. 7 is an example of a cross-sectional view cut along a line D-D in FIG. 6;

FIG. 8 is an example of a cross-sectional view cut along a line C-C in FIG. 6;

FIG. 9 is a perspective view of an example of the communication module from which the protection member illustrated in FIG. 4 is removed;

FIG. 10 is a front view of an example of the communication module illustrated in FIG. 9;

FIG. 11 is a plan view of an example of the communication module illustrated in FIG. 9;

FIG. 12 is a side view of an example of the communication module illustrated in FIG. 9;

FIG. 13 is an example of a cross-sectional view cut along a line A-A in FIG. 12;

FIG. 14 is a perspective view of an example of a holder;

FIG. 15 is a front view of an example of the holder;

FIG. 16 is a plan view of an example of the holder;

FIG. 17 is a side view of an example of the holder;

FIG. 18 is an example of a cross-sectional view cut along a line B-B in FIG. 17;

FIG. 19 is a perspective view of an example of an upper cover from a viewpoint from a cover inner face;

FIG. 20 illustrates an example of the buckle from a viewpoint from the upper cover;

FIG. 21 is an example of a cross-sectional view cut along a line F-F in FIG. 20;

FIG. 22 is a side view of an example of the buckle;

FIG. 23 is an example of a cross-sectional view cut along a line E-E in FIG. 22;

FIG. 24 is a perspective view of an example of an upper cover from a viewpoint from the cover inner face;

FIG. 25 illustrates an example of the buckle from a viewpoint from the upper cover;

FIG. 26 is an example of a cross-sectional view cut along a line G-G in FIG. 25;

FIG. 27 is an example of a cross-sectional view cut along a line I-I in FIG. 25;

FIG. 28 is a side view of an example of the buckle; and

FIG. 29 is an example of a cross-sectional view cut along a line H-H in FIG. 28.

### DESCRIPTION OF THE PREFERRED EMBODIMENTS

In the following, embodiments of the present invention will be described with reference to the accompanying drawings.

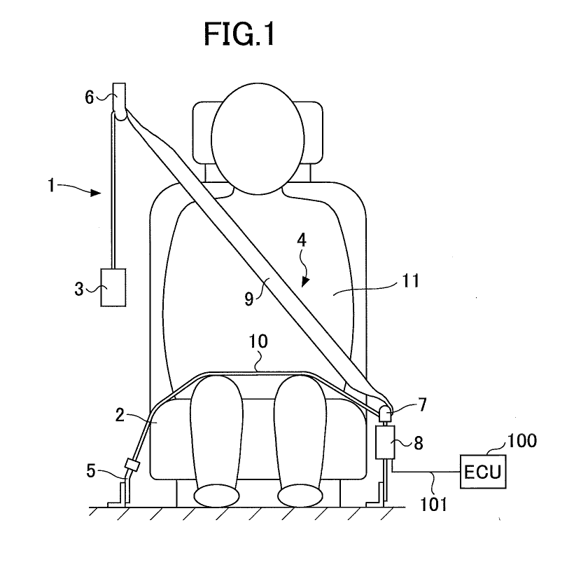

FIG. 1 illustrates an example of a configuration of a seatbelt apparatus 1 according to an embodiment. The seatbelt apparatus 1 is an example of an in-vehicle system installed in a vehicle. The seatbelt apparatus 1 includes, for example, a seatbelt 4, a retractor 3, a shoulder anchor 6, a tongue 7, a buckle 8, and an ECU (Electronic Control Unit) 100.

The seatbelt 4 is an example of a webbing for restraining a passenger 11 sitting in a seat 2 of the vehicle. The seatbelt 4 is a belt type member that can be wound up in the retractor 3 and pulled out from the retractor 3. A belt anchor 5, which is at the leading end of the seatbelt 4, is fixed to the floor of the vehicle body or to the seat 2.

The retractor 3 is a winding device by which the seatbelt 4 can be wound up or pulled out. When the vehicle decelerates by greater than or equal to a predetermined value, such as when the vehicle collides with another object, the seatbelt 4 is restricted from being pulled out from the retractor 3. The retractor 3 is fixed to the seat 2, or to the vehicle body near the seat 2.

The shoulder anchor 6 is an example of a belt insertion tool to which the seatbelt 4 is inserted. The shoulder anchor 6 is a member that guides the seatbelt 4, which is pulled out from the retractor 3, towards the shoulder of the passenger 11.

The tongue 7 is an example of a belt insertion tool to which the seatbelt 4 is inserted. The tongue 7 is a component that is slidably attached to the seatbelt 4 that is guided by the shoulder anchor 6.

The buckle 8 is a component to which the buckle 8 is detachably coupled. For example, the buckle 8 is fixed to the floor of the vehicle or to the seat 2.

In a state where the tongue 7 is engaged with the buckle 8, the part of the seatbelt 4 between the shoulder anchor 6 and the tongue 7 is a shoulder belt part 9 that restrains the breast part and the shoulder part of the passenger 11. In a state where the tongue 7 is engaged with the buckle 8, the part of the seatbelt 4 between the belt anchor 5 and the tongue 7 is a lap belt part 10 that restrains the hip part of the passenger 11.

The ECU 100 is an example of an electronic control device that is communicatively coupled to the buckle 8 via wire harnesses 101. The number of wire harnesses 101 is determined according to the communication standard. The communication standard between the buckle 8 and the ECU 100 is, for example, LIN.

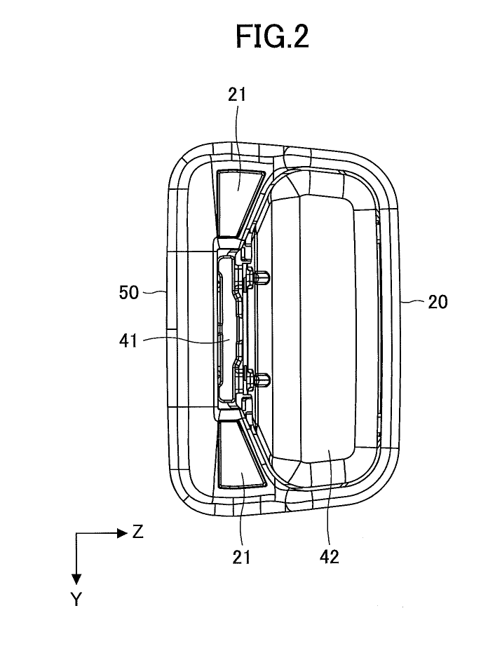

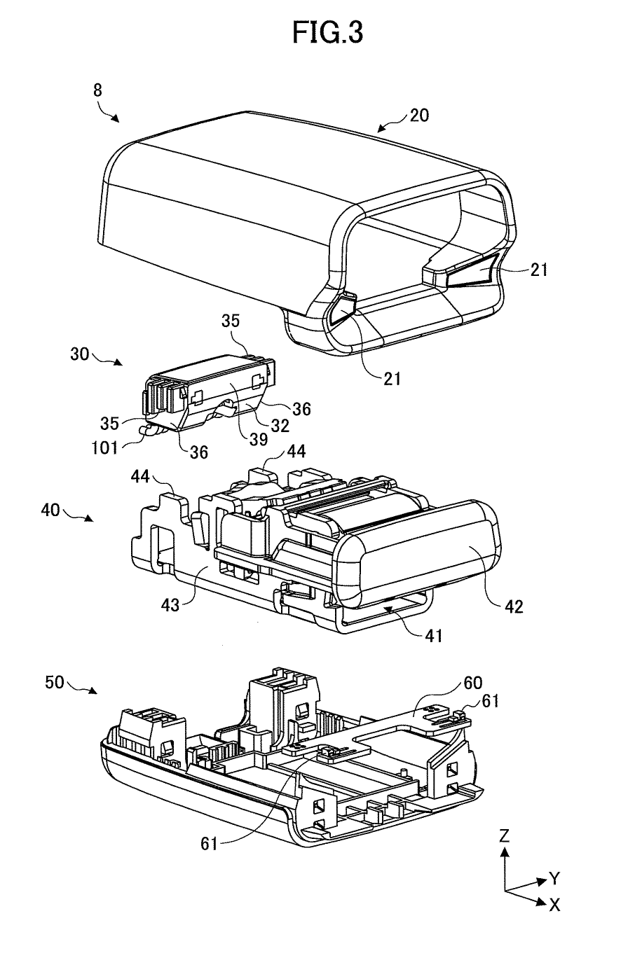

FIG. 2 illustrates an example of the buckle 8 from a viewpoint from the upper part of the vehicle. FIG. 3 is an exploded perspective view of an example of the configuration of the buckle 8. The buckle 8 includes, for example, a main body part 40, an upper cover 20, a lower cover 50, a communication module 30, and an illumination substrate 60.

A direction parallel to the X axis (X axis direction) indicates the vertical direction of the vehicle in the state where the buckle 8 is attached to the vehicle. A direction parallel to the Y axis (Y axis direction) indicates the direction extending between the front and the back of the vehicle in a state where the buckle 8 is attached to the vehicle. A direction parallel to the Z axis (Z axis direction) indicates the direction extending between the right and the left of the vehicle (vehicle width direction) in a state where the buckle 8 is attached to the vehicle.

The main body part 40 is a sub-assembly component that can be coupled to the tongue 7 attached to the seatbelt 4. The main body part 40 includes, for example, an insertion opening 41 into which a metal plate of the tongue 7 is inserted, a button 42 used by the passenger 11 for operating the attachment and the detachment of the tongue 7, and a buckle base 43 for holding the components such as the button 42 constituting the main body part 40.

The upper cover 20 is an example of a buckle cover for covering the main body part 40 and the communication module 30 in a manner that the button 42 is exposed. The upper cover 20 is a resin component for holding the main body part 40 and the communication module 30, by sandwiching these with the lower cover 50.

The lower cover 50 is an example of a buckle cover having an inside surface to which the illumination substrate 60 is fixed. The lower cover 50 is a resin component covering the illumination substrate 60.

The upper cover 20 and the lower cover 50 are external covers of the buckle 8, and form a housing case for accommodating the main body part 40, the communication module 30, and the illumination substrate 60. In the present embodiment, the external cover of the buckle 8 is formed by the two components, i.e., the upper cover 20 and the lower cover 50, for accommodating the main body part 40, the communication module 30, and the illumination substrate 60; however, the external cover of the buckle 8 may be formed by three components.

In a state where the buckle 8 is attached to the vehicle, the upper cover 20 faces the opposite side to the passenger 11, and the lower cover 50 faces the side of the passenger 11.

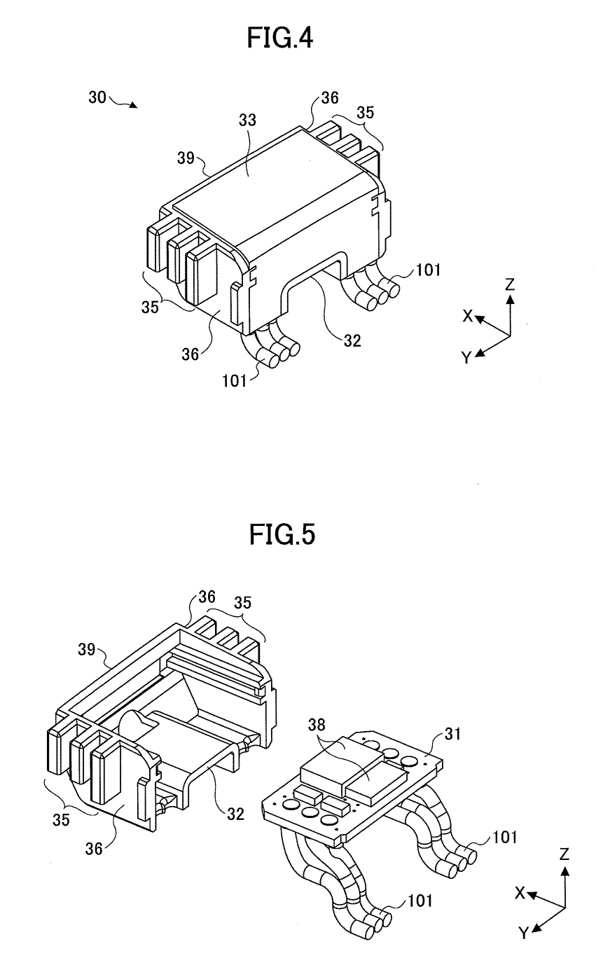

FIG. 4 is a perspective view of an example of the communication module 30. FIG. 5 is an exploded perspective view of an example of the communication module 30. A protection member 33 illustrated in FIG. 4, is omitted in FIG. 5. The communication module 30 includes a communication substrate 31, the protection member 33, and a holder 32.

To the communication substrate 31, the ends of six wire harnesses 101 are coupled. The end of each wire harness 101 is coupled to the communication substrate 31 by soldering; however, the end of each wire harness 101 may be coupled to the communication substrate 31 by a connector. In the diagrams, the ends of the wire harnesses 101 are coupled to the substrate surface on the back side of the communication substrate 31. The communication substrate 31 is, for example, a LIN substrate. On the communication substrate 31, components having functions other than the communication function may be mounted.

On the communication substrate 31, one or more control circuits 38 are mounted. In the drawings, the control circuits 38 are mounted on the substrate surface on the front side of the communication substrate 31. The control circuits 38 are communicatively coupled to the ECU 100 that is arranged outside the buckle 8, via the wire harnesses 101.

For example, the control circuits 38 output flickering control signals for controlling the flickering of luminescent materials 61 mounted on the illumination substrate 60 (see FIG. 3), based on control signals from the ECU 100. A specific example of the luminescent material 61 is a light emitting diode. The flickering of the luminescent materials 61 can be seen from outside the buckle 8, through reflectors 21 (see FIGS. 2 and 3) provided on the upper cover 20.

The control circuits 38 cause the blinking or the flickering of the luminescent materials 61, for example, when door open signals, which express that the door of the vehicle is open, are received from the ECU 100 via the wire harnesses 101. Accordingly, the reflectors 21 arranged near the insertion opening 41 blink or flicker, and therefore the passenger 11 is able to easily recognize the position of the insertion opening 41, even in the darkness. Furthermore, the blinking or the flickering can prompt the passenger 11 to wear the seatbelt 4.

The control circuits 38 may send predetermined information to the ECU 100 via the wire harnesses 101. For example, the control circuits 38 sends buckle switch signals to the ECU 100 via the wire harnesses 101. The buckle switch signals express a detection state of whether the tongue 7 attached to the seatbelt 4 and the main body part 40 are coupled to each other.

The protection member 33 illustrated in FIG. 4 is an example of a member for protecting the protection targets (for example, the communication substrate 31, the control circuits 38, and the coupling parts between the ends of the wire harnesses 101 and the communication substrate 31, etc.). The protection member 33 is formed by an insulating body. For example, the periphery of the protection targets is fixed by the protection member 33 such as resin. The protection member 33 can protect the protection targets from liquid and electric shortages caused by foreign substance. Furthermore, the protection member 33 may provide a vibration proof function and a water proof function for the protection targets. Furthermore, the protection member 33 can reduce the load, which is applied by an external force by pulling the wire harnesses 101, on the coupling parts between the ends of the wire harnesses 101 and the communication substrate 31.

The holder 32 supports the communication substrate 31. The holder 32 is, for example, a component in which resin is the main component. The holder 32 supports the communication substrate 31 parallel to an XY plane. The holder 32 is a substantially rectangular housing case surrounded by four outer walls. The holder 32 includes a pair of outer walls 36 facing each other in the Y axis direction and a side wall 39 having both edges coupled to the pair of outer walls 36. The holder 32 includes a plurality of outside ribs 35 protruding outward from the respective outer walls 36. The outside ribs 35 extend in the Z axis direction.

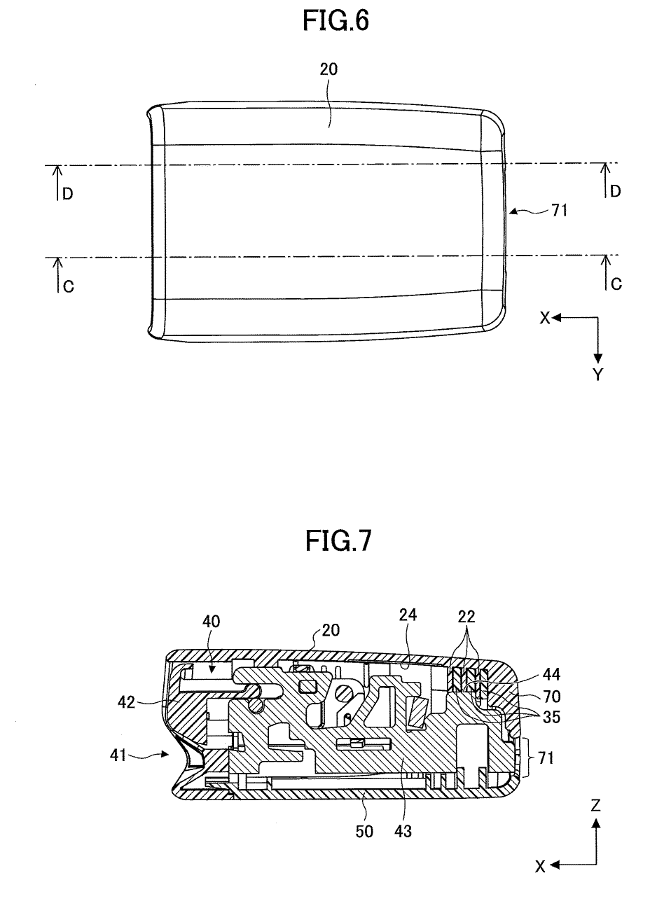

FIG. 6 illustrates an example of the buckle 8 from the viewpoint from the upper cover 20. FIG. 7 is an example of a cross-sectional view cut along a line D-D in FIG. 6.

The upper cover 20 includes a cover inner face 24 having a plurality of ribs 22 that protrude toward the inside of the upper cover 20. The upper cover 20 sandwiches the outside ribs 35 of the holder 32 between the plurality of ribs 22, in the X axis direction.

The holder 32 is fixed by being sandwiched between the buckle base 43 of the main body part 40 and the upper cover 20. Specifically, the outside ribs 35 of the holder 32 are sandwiched between a base face 44 of the buckle base 43 and the cover inner face 24 of the upper cover 20 in the Z axis direction, and the outside ribs 35 are sandwiched between adjacent ribs 22 in the X axis direction.

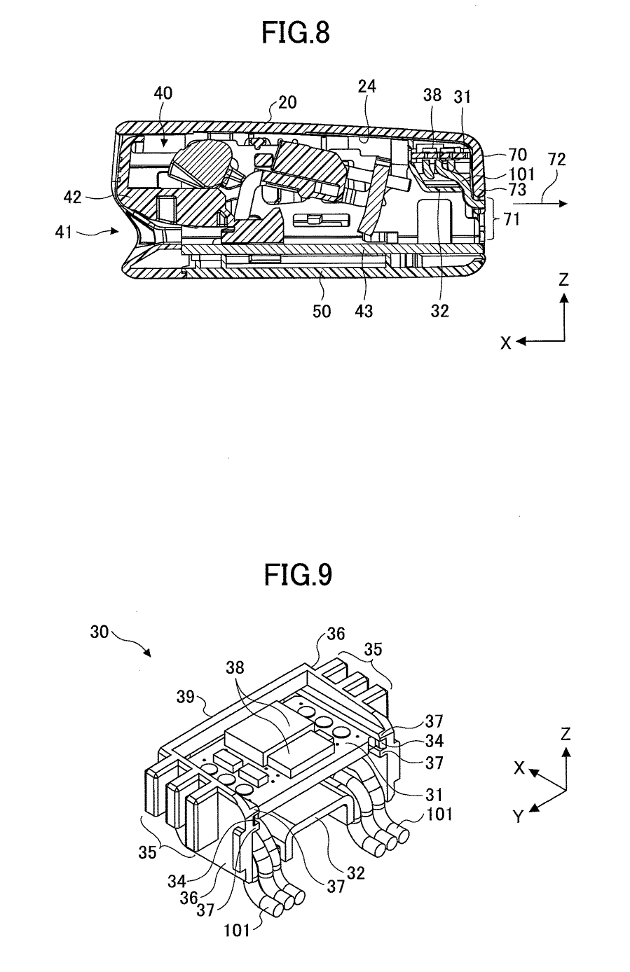

FIG. 8 is an example of a cross-sectional view cut along a line C-C in FIG. 6. The wire harnesses 101 pass through an opening 71 formed in a buckle front surface 70. The buckle front surface 70 is the front surface of the buckle 8; for example, the front surface of the buckle 8 is the surface of the buckle 8 at the bottom side of the vehicle in a state where the buckle 8 is attached to the vehicle. The opening 71 is formed by the rim of the upper cover 20 and the rim of the lower cover 50. The opening 71 may be a through hole formed in the upper cover 20 or the lower cover 50. The holder 32 supports the communication substrate 31 to which the ends of the wire harness 101 are coupled.

The wire harnesses 101 having one end coupled to the communication substrate 31 are pulled out from the opening 71 and extend in an opening direction 72 of the opening 71. The opening direction 72 is in a direction parallel to the X axis direction in the drawing. To the wire harness 101, a tensile force may be applied in the opening direction 72, when the buckle 8 is attached to the vehicle and when the vehicle travels and oscillates.

In the present embodiment, as illustrated in FIGS. 7 and 8, the upper cover 20 includes ribs 22 that are orthogonal to the opening direction 72 parallel to the X axis direction. Therefore, even when the wire harness 101 is pulled in the opening direction 72, the holder 32 supporting the communication substrate 31 is prevented from moving in the opening direction 72, by the ribs 22. Therefore, the communication substrate 31 can be prevented from falling off from the upper cover 20 in the opening direction 72 together with the holder 32.

Furthermore, as the outside ribs 35 of the holder 32 contact the ribs 22 in the opening direction 72, the movement of the holder 32 in the opening direction 72 is stopped. Therefore, even when the wire harness 101 is pulled in the opening direction 72, the ribs 22 prevent the holder 32 supporting the communication substrate 31 from rotating on an opening rim 73 of the opening 71 acting as the fulcrum of rotation. The opening rim 73 is the rim part of the upper cover 20. Therefore, the communication substrate 31 is prevented from rotating together with the holder 32, on the opening rim 73 acting as the fulcrum of rotation, and falling off from the upper cover 20.

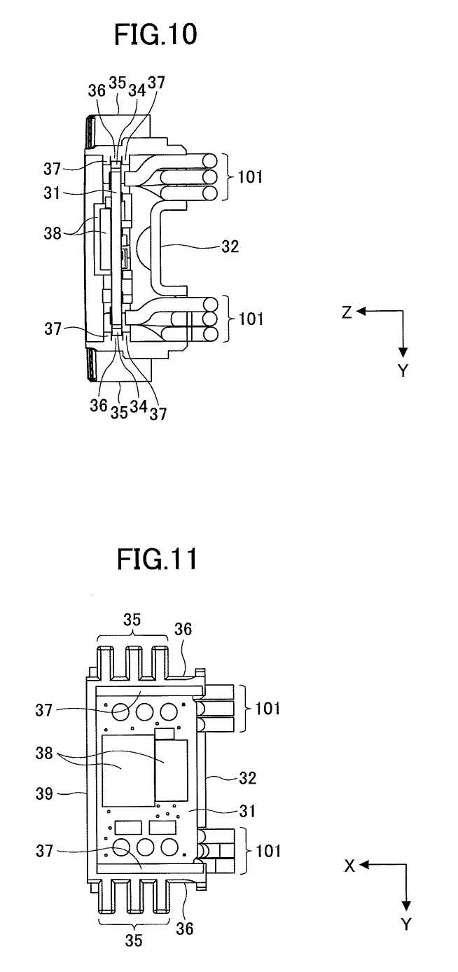

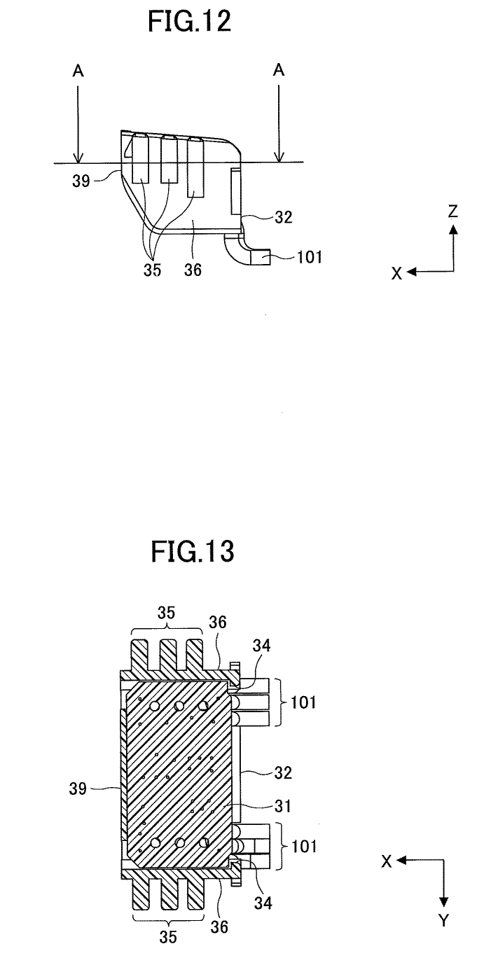

FIG. 9 is a perspective view of an example of the communication module 30 from which the protection member 33 illustrated in FIG. 4 is removed. FIG. 10 is a front view of an example of the communication module 30 illustrated in FIG. 9. FIG. 11 is a plan view of an example of the communication module 30 illustrated in FIG. 9. FIG. 12 is a side view of an example of the communication module 30 illustrated in FIG. 9. FIG. 13 is an example of a cross-sectional view cut along a line A-A in FIG. 12.

The communication substrate 31 is inserted in between the pair of outer walls 36 of the holder 32, from the side opposite to the side wall 39, in the X axis direction parallel to the opening direction 72. The holder 32 includes a plurality of substrate support ribs 37 protruding inward from the pair of outer walls 36. The substrate support ribs 37 support the edge part of the communication substrate 31, and extend in the X axis direction.

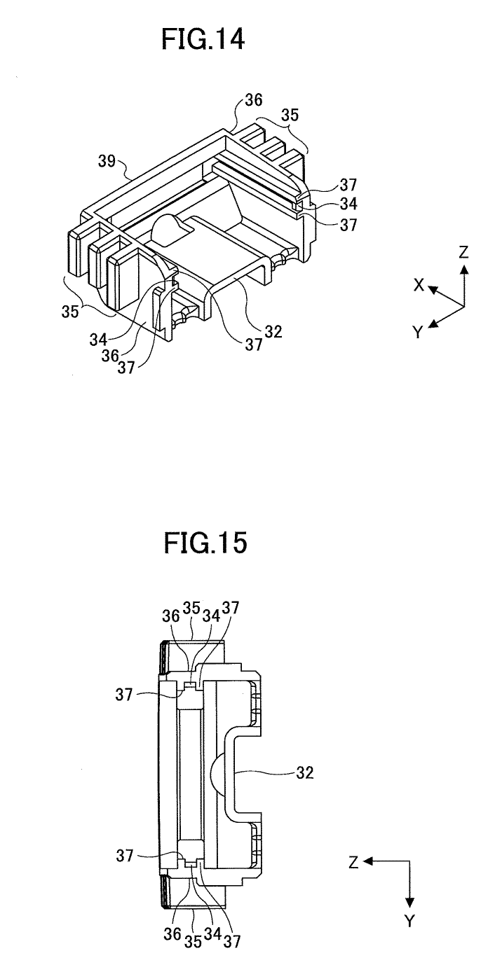

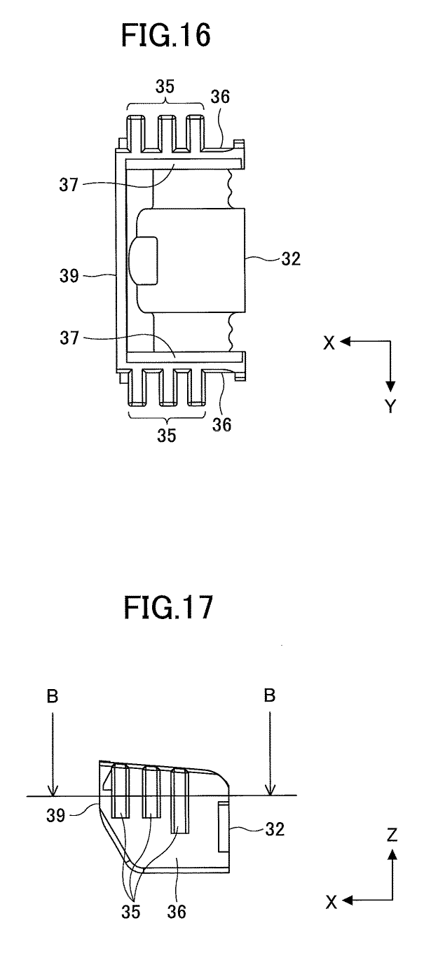

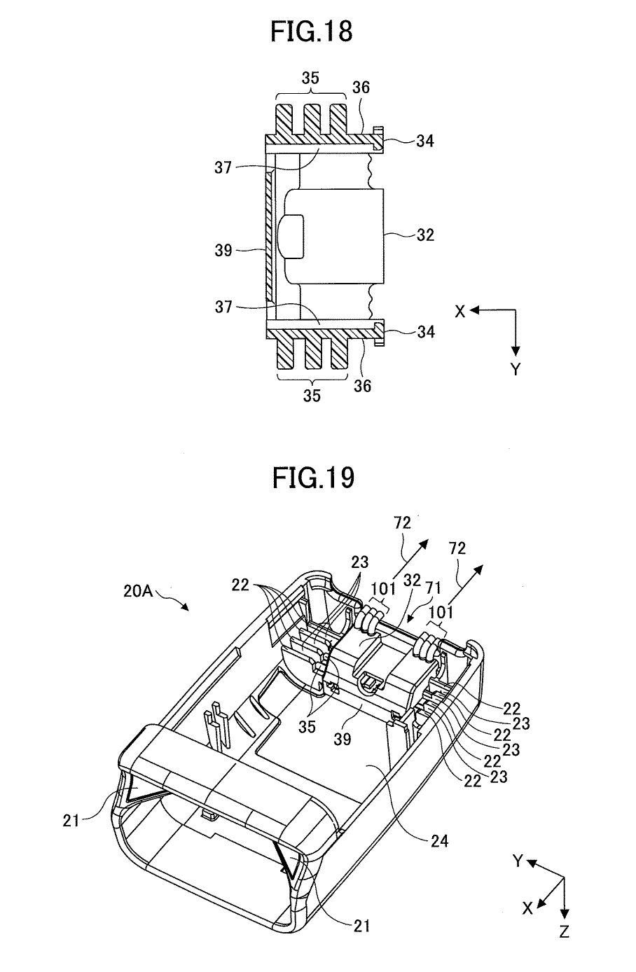

FIG. 14 is a perspective view of an example of the holder 32. FIG. 15 is a front view of an example of the holder 32. FIG. 16 is a plan view of an example of the holder 32. FIG. 17 is a side view of an example of the holder 32. FIG. 18 is an example of a cross-sectional view cut along a line B-B in FIG. 17.

The pair of substrate support ribs 37 extending in the X axis direction is provided on one of the outer walls 36, and another pair of substrate support ribs 37 extending in the X axis direction is provided on the other one of the outer walls 36. The holder 32 supports both edges of the communication substrate 31 with the pairs of the substrate support ribs 37 on the pair of outer walls 36. The substrate support ribs 37 in each pair are spaced apart in the Z direction, and the communication substrate 31 is slidably inserted in the space between the substrate support ribs 37.

At the insertion openings for the communication substrate 31 in the pair of substrate support ribs 37, hook type stoppers 34 are provided. When starting to insert the communication substrate 31, the stoppers 34, which are provided on the respective outer walls 36, bend and expand in the Y axis direction, and the communication substrate 31 is inserted. When the communication substrate 31 is completely inserted, the stoppers 34 are narrowed in the Y axis direction by the elastic force of the stoppers 34. Accordingly, the communication substrate 31, which has been inserted in the holder 32, is prevented from moving in the X axis direction parallel to the opening direction 72, by the stoppers 34.

FIG. 19 is a perspective view of an example of an upper cover 20A from a viewpoint from the cover inner face 24. The upper cover 20A is an example of the upper cover 20.

The upper cover 20A includes the plurality of ribs 22 protruding from the cover inner face 24. The plurality of ribs 22 respectively include rib side faces 23 orthogonal to the opening direction 72, and the rib side faces 23 prevent the movement of the holder 32. The upper cover 20A prevents the rotation of the holder 32 by sandwiching the outside ribs 35 of the holder 32 in between the plurality of adjacent ribs 22 by the rib side faces 23.

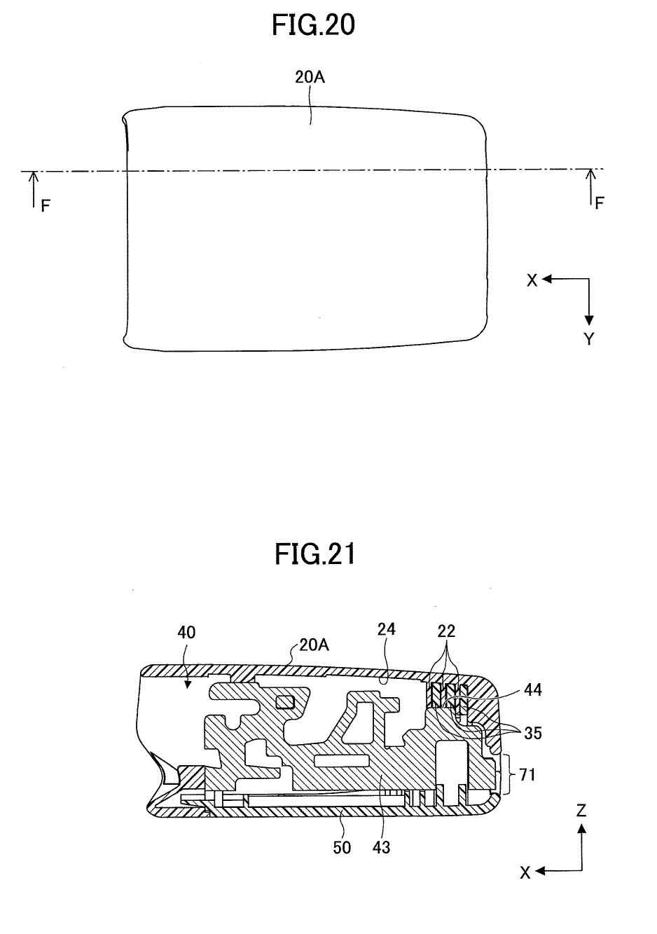

FIG. 20 illustrates an example of the buckle 8 from a viewpoint from the upper cover 20A. FIG. 21 is an example of a cross-sectional view cut along a line F-F in FIG. 20.

The holder 32 is fixed by being sandwiched in between the buckle base 43 of the main body part 40 and the upper cover 20A. Specifically, the outside ribs 35 of the holder 32 are sandwiched between the base face 44 of the buckle base 43 and the cover inner face 24 of the upper cover 20A in the Z axis direction, and the outside ribs 35 of the holder 32 are sandwiched between the adjacent ribs 22 in the X axis direction.

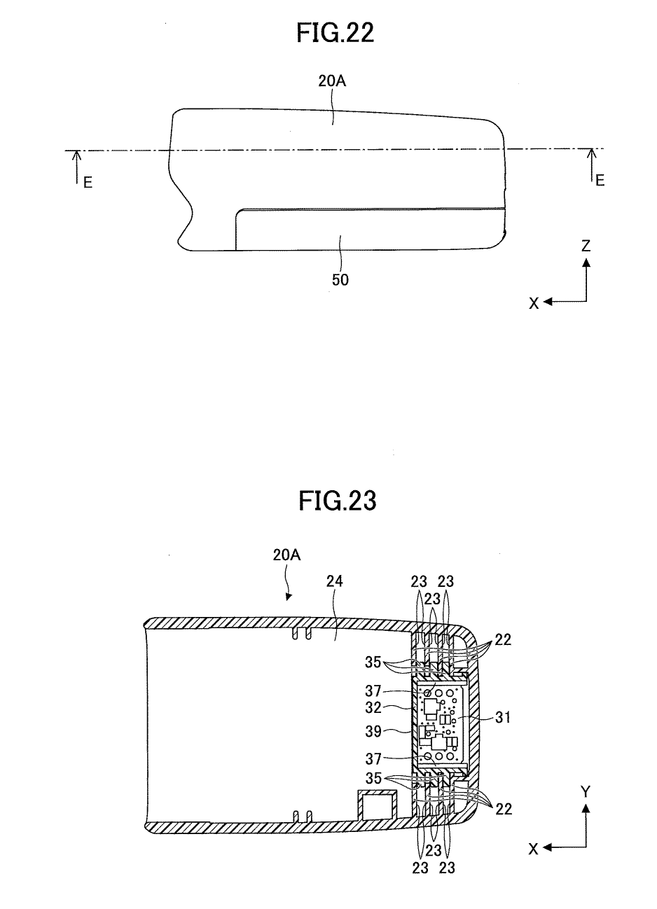

FIG. 22 is a side view of an example of the buckle 8 including the upper cover 20A. FIG. 23 is an example of a cross-sectional view cut along a line E-E in FIG. 22.

At least one of the outside ribs 35 of the holder 32 is sandwiched between at least two of the plurality of ribs 22 of the upper cover 20A by the rib side faces 23. Accordingly, the holder 32 is stopped from moving in the X axis direction parallel to the opening direction 72 together with the communication substrate 31.

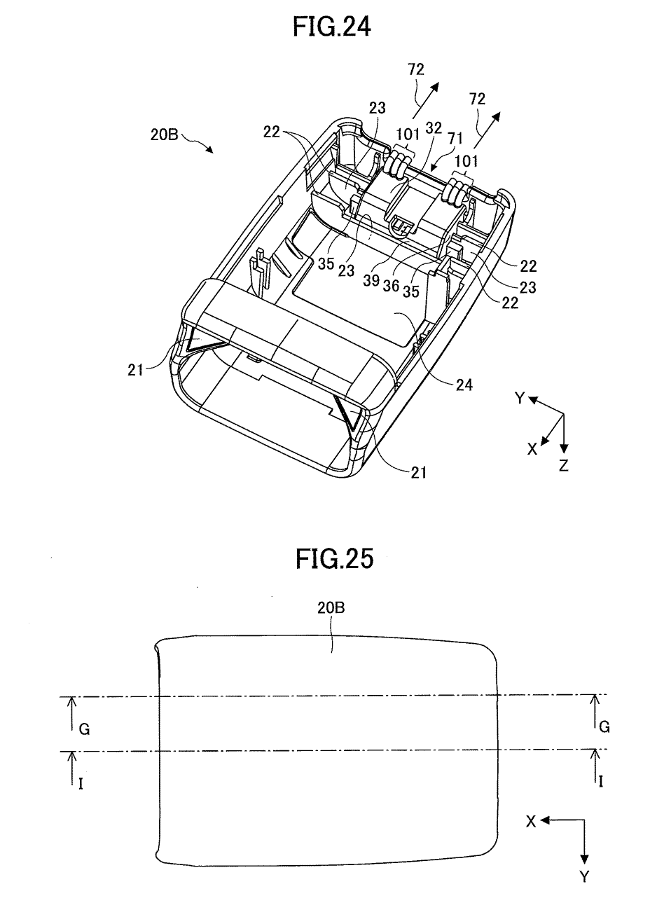

FIG. 24 is a perspective view of an example of an upper cover 20B from a viewpoint from the cover inner face 24. The upper cover 20B is an example of the upper cover 20.

The upper cover 20B includes the plurality of ribs 22 protruding from the cover inner face 24. The plurality of ribs 22 respectively include the rib side faces 23 orthogonal to the opening direction 72, and the rib side faces 23 prevent the movement of the holder 32. The upper cover 20B sandwiches the outside ribs 35 of the holder 32 in between the plurality of adjacent ribs 22 by the rib side faces 23.

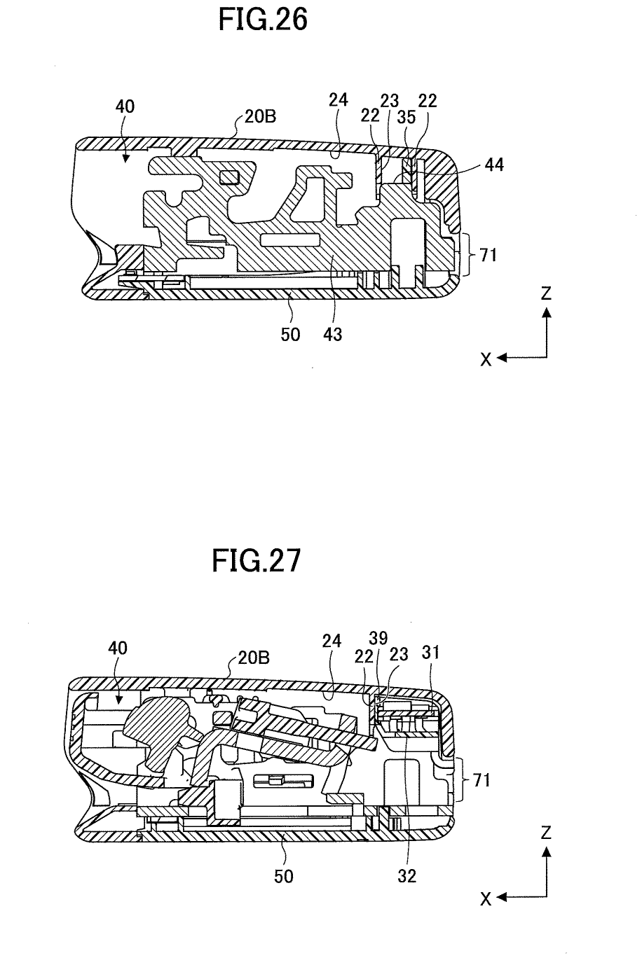

FIG. 25 illustrates an example of the buckle 8 from a viewpoint from the upper cover 20B. FIG. 26 is an example of a cross-sectional view cut along a line G-G in FIG. 25.

The holder 32 is fixed by being sandwiched in between the buckle base 43 of the main body part 40 and the upper cover 20B. Specifically, the outside ribs 35 of the holder 32 are sandwiched between the base face 44 of the buckle base 43 and the cover inner face 24 of the upper cover 20B in the Z axis direction, and the outside ribs 35 of the holder 32 are sandwiched between the adjacent ribs 22 in the X axis direction.

FIG. 27 is an example of a cross-sectional view cut along a line I-I in FIG. 25. The side wall 39 of the holder 32 abuts the rib 22 in the X axis direction parallel to the opening direction 72. Accordingly, the holder 32 is stopped from moving in the opening direction 72 together with the communication substrate 31.

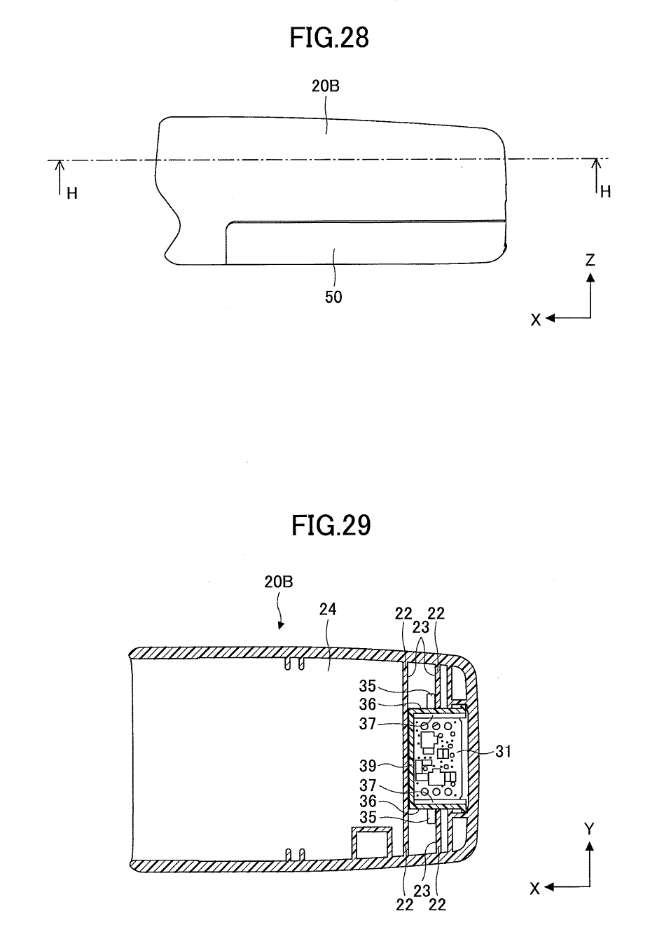

FIG. 28 is a side view of an example of the buckle 8 including the upper cover 20B. FIG. 29 is an example of a cross-sectional view cut along a line H-H in FIG. 28.

At least one of the outside ribs 35 of the holder 32 is sandwiched between two of the ribs 22 of the upper cover 20B by the rib side faces 23. The outside rib 35 abuts the rib 22 closer to the opening 71, and the side wall 39 abuts the rib 22 away from the opening 71. Accordingly, the holder 32 is stopped from moving in the opening direction 72 together with the communication substrate 31.

Although the buckle has been described with reference to preferred embodiments, the present invention is not limited to these embodiments. Any one of these embodiments may be modified in various manners such as to be combined with part or all of the other embodiments, or partly replaced with part of the other embodiments.

For example, the communication standard between the buckle 8 and the ECU 100 is not limited LIN; another communication standard may be used, such as CAN (Controller Area Network).

Furthermore, for example, the seat 2 may be a front seat or a back seat of the vehicle.

The present application is based on Japanese priority application No. 2016-101321 filed on May 20, 2016, with the Japanese Patent Office, the entire contents of which are hereby incorporated by reference.

What is claimed is:

1. A buckle comprising:
a main body part that can be coupled to a tongue that is attached to a seatbelt of a vehicle;
a communication substrate to which one end of a wire harness is coupled, the wire harness passing through an opening formed on a buckle surface of the buckle;
a holder configured to support the communication substrate; and
a cover configured to cover the main body part, the communication substrate, and the holder,
wherein the cover includes a rib that prevents the holder from moving in an opening direction of the opening.

2. The buckle according to claim 1, wherein the rib prevents the holder from rotating on an opening rim of the opening acting as a fulcrum of the rotation.

3. The buckle according to claim 2, wherein the cover prevents the rotation of the holder by sandwiching the holder with the main body part.

4. The buckle according to claim 1, wherein
the rib includes a rib side face orthogonal to the opening direction, and
the rib side face prevents the holder from moving.

5. The buckle according to claim 4, wherein
the cover includes a plurality of the ribs, and
the cover sandwiches the holder in between the plurality of the ribs by the rib side faces.

6. The buckle according to claim 5, wherein
the cover sandwiches an outside rib, which protrudes outward from an outer wall of the holder, by the rib side faces.

7. The buckle according to claim 6, wherein
the holder includes a pair of the outer walls that are parallel to the opening direction, and
the outside ribs protrude from the respective outer walls.

8. The buckle according to claim 1, wherein the holder includes substrate support ribs configured to support the communication substrate so as to be parallel to the opening direction.

9. The buckle according to claim 8, wherein the substrate support ribs protrude inward from each outer wall of the holder.

10. The buckle according to claim 1, wherein the holder includes a stopper that prevents the communication substrate from moving in the opening direction.
substrate support ribs protrude inward from each outer wall of the holder.
